(19) United States
(12) Patent Application Publication
(10) Pub. No.: US 2025/0029338 A1
(43) Pub. Date: Jan. 23, 2025

(54) PREDICTION AND MITIGATION OF HAZARDOUS CONDITIONS

(71) Applicant: INTERNATIONAL BUSINESS MACHINES CORPORATION, Armonk, NY (US)

(72) Inventors: Jeremy R. Fox, Georgetown, TX (US); Atul Mene, Morrisville, NC (US); Tushar Agrawal, West Fargo, ND (US); Sarbajit K. Rakshit, Kolkata (IN)

(21) Appl. No.: 18/356,382

(22) Filed: Jul. 21, 2023

(51) Int. Cl. G06T 19/00

(52) U.S. Cl. CPC G06T 19/003

(57) ABSTRACT

Computer implemented methods, systems, and computer program products include program code executing on a processor(s) that monitors one or more individuals within the physical space. The program code detects a stimulus within the physical space. The program code determines, based on applying a trained machine learning model, that the stimulus will result in a hazardous condition in the physical space. To make this determination, the program code predicts, based on the model, that the stimulus will trigger a reflexive movement of at least one individual of the one or more individuals in the physical space and determines, based on the model and based on the predicted reflexive movement that the reflexive movement will result in a hazardous condition in the physical space. The program code initiates a remedial action to mitigate the hazardous condition.

### BACKGROUND

The present invention relates generally to the field of artificial intelligence (AI) in computing and specifically, utilizing machine learning to maintain safety in a physical environment.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed. Augmented reality (AR) is a technology that superimposes a computer-generated image on a user's view of the real world, thus providing a composite view. AR can include real-time uses of information in the form of text, graphics, audio, and other virtual enhancements integrated with real-world objects. AR differs from virtual reality (VR) because of the composite information it provides; AR utilizes real world elements and enhances the real-world elements with virtual elements, including what would be considered VR. AR utilizes existing real-world environment and puts virtual information—or even a virtual world—on top of it to enhance the experience.

Unplanned movements by workers can create hazards for those workers and their peers in industrial environments. Reflexive reactions to stimuli are a source of these reactions. Individuals can take different levels of precautions while carrying out the same activity and these levels are reflected when these individuals are in control of their action, but when an individual reflexively reacts to stimuli, the individual does not have this level of control. A reflexive action can be a response of the human body to a stimulus or to a sudden change in the individual's environment. The individual received this kind of sensation by a receptor in the individual's body and a sensory neuron sends a signal to other neurons leading to the individual's spinal cord. In a reflex action the signals do not route to the brain and are instead directed to the spinal cord and therefore, the reaction of the individual to the environmental stimulus is almost instantaneous. Reactions to stimulus by the human body are instantaneous and can include pulling away of a hand or the jerking aware of a knee. Because an individual experiencing this type of reaction is not actively controlling the movement (it is a reflexive reaction), reflexive reactions can create hazards in various environments where controlled and specific motions maintain the individual's safety and the safety of those who share the environment.

### SUMMARY

Shortcomings of the prior art are overcome, and additional advantages are provided through the provision of a computer-implemented method for anticipating and mitigating hazardous conditions in a physical space. The computer-implemented method can include: monitoring, by one or more processors, one or more individuals within the physical space; detecting, by the one or more processors, a stimulus within the physical space; determining, by the one or more processors, based on applying a trained machine learning model, that the stimulus will result in a hazardous condition in the physical space, the determining comprising: predicting, by the one or more processors, based on the model, that the stimulus will trigger a reflexive movement of at least one individual of the one or more individuals in the physical space; and determining, by the one or more processors, based on the model and based on the predicted reflexive movement that the reflexive movement will result in a hazardous condition in the physical space; and initiating, by the one or more processors, a remedial action to mitigate the hazardous condition.

Shortcomings of the prior art are overcome, and additional advantages are provided through the provision of a computer program product for anticipating and mitigating hazardous conditions in a physical space. The computer program product comprises a storage medium readable by one or more processors and storing instructions for execution by the one or more processors for performing a method. The method includes, for instance: monitoring, by the one or more processors, one or more individuals within the physical space; detecting, by the one or more processors, a stimulus within the physical space; determining, by the one or more processors, based on applying a trained machine learning model, that the stimulus will result in a hazardous condition in the physical space, the determining comprising: predicting, by the one or more processors, based on the model, that the stimulus will trigger a reflexive movement of at least one individual of the one or more individuals in the physical space; and determining, by the one or more processors, based on the model and based on the predicted reflexive movement that the reflexive movement will result in a hazardous condition in the physical space; and initiating, by the one or more processors, a remedial action to mitigate the hazardous condition.

Shortcomings of the prior art are overcome, and additional advantages are provided through the provision of a system for anticipating and mitigating hazardous conditions in a physical space. The system includes: a memory, one or more processors in communication with the memory, and program instructions executable by the one or more processors via the memory to perform a method. The method includes, for instance: monitoring, by the one or more processors, one or more individuals within the physical space; detecting, by the one or more processors, a stimulus within the physical space; determining, by the one or more processors, based on applying a trained machine learning model, that the stimulus will result in a hazardous condition in the physical space, the determining comprising: predicting, by the one or more processors, based on the model, that the stimulus will trigger a reflexive movement of at least one individual of the one or more individuals in the physical space; and determining, by the one or more processors, based on the model and based on the predicted reflexive movement that the reflexive movement will result in a hazardous condition in the physical space; and initiating, by the one or more processors, a remedial action to mitigate the hazardous condition.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a workflow that provides an overview of various aspects performed by the program code (executing on one or more processors) in some embodiments of the present invention;

FIG. 3 illustrates various aspects of some embodiments of the present invention; and

FIG. 4 illustrates aspects of a technical environment and a workflow into which aspects of some embodiments of the present invention have been implemented.

### DETAILED DESCRIPTION

Embodiments of the present invention include computer-implemented methods, computer program products, and computer systems that include program code that when executed by one or more processors, predicts reflexive movements of individuals, including but not limited to, the movements themselves as well as the direction of those movements, when these reflexive movements are in involuntary (e.g., neurological, nerve, etc.) responses to stimuli. Aspects of various embodiments of the present invention are directed to a practical application because by utilizing machine learning to anticipate unintentional movements of individuals, the safety of that individual and those within the shared physical environment is improved. One such environment where the bodily safety of an individual experiencing a reflexive response to stimuli and of those with the vicinity of the individual is important is a shared workspace. By anticipating these involuntary movements, various accidents can be prevented and the physical environment as well as the people who inhabit the physical environment can be protected. In some examples, program code executing on one or more processors can utilize historical data (machine learning these historical data) to predict both an individual's and the potential impacts of those movement on the physical environment of the individual, including both other individuals and inanimate objects in the individual's vicinity, this preventing potential accidents.

As will be described in greater details herein, in embodiments of the present invention, program code executing on one or more processors improved the safety of physical environments. To improve the physical safety of an environment and its inhabitants, the program code monitors the environment of an individual and detects stimuli within the environment. For example, the program code can monitor an individual's activities by receiving input corresponding to these activities. In some examples, based on detecting a given stimulus, the program code can utilize a trained machine learning algorithm to predict reflexive movements of an individual should the individual's reflexes become triggered by the given stimulus. To train the algorithm, the program code can analyze input data corresponding to historical data from the individual to determine the historical reflex actions of the individual. The program code can determine whether the reflexive movement the program code predicted is likely to cause an injury. Based on determining that there is a likelihood of injury based on a predicted movement, the program code can trigger and/or take a remedial action to prevent the predicted injury from occurring. The remedial action can be a recommendation of an action that will present the reflexive action. The program code can customize the remedial actions based on the predicted reflexive movement (which is based on the historical data related to past movements of the individual). In some examples, the remedial action can be additional data gathering, for example the program code can trigger additional analysis of input data corresponding to historical data from people other than the individual to determine generalized historical reflex actions. The program code can then recommend and/or generate a remedial action based on the anticipated generalized reflective reaction.

Aspects of embodiments described herein are inextricably tied to computing and provide significantly more than existing physical environment safety technologies. As will be discussed in greater detail herein, the examples herein utilize both AI (e.g., machine learning) and AR technologies in order to increase the safety of physical environments. In the examples herein, while AI is utilized to anticipate and hence prevent accidents, AR is utilized in avoiding or preventing the predicted (utilizing machine learning) hazard. These technologies are inextricably tied to the approach herein as together, they enable both the anticipation of issues in a physical environment and the mitigation of these issues. Embodiments of the present invention leverage a combination of AI (e.g., machine learning) and AR to predict (e.g., AI) accidents caused by individuals (based on anticipated reflexive actions by individual in response to stimuli) and to display (e.g., AR) these potential accidents and/or actions for mitigation or prevention of these anticipated accidents to the individuals.

Systems in which aspects of the present invention are implemented can include an AR glasses which an individual (e.g., user) can wear and in which the program code can display a potential accident predicted (by the program code) based on an anticipated reflexive reaction of the individual to a stimulus in the individual's physical environment. The program code can utilize the AR glasses to project, to the individual, in the physical environment, information about the potential accident (the virtual portion of the projection is the predicted accident while the physical environment is the real portion of the AR images projected by the program code). The program code can utilize devices worn by the user to alert the user to the predicted accident or hazard. The wearable devices can include Internet of Things (IoT) devices. Various AR glasses can be utilized in the computer-implemented method, computer program products, and computer systems described herein, including but not limited to Apple Vision Pro, the Wireless AR Smart Viewer, the Snapdragon XR1 AR Smart Viewer, and/or any other commercially available AR glasses.

Regarding the use of AI in embodiments of the present invention, as will be explained in greater detail herein, program code in embodiments of the present invention can utilize historical learning (machine learning) to predict an individual's movement and a potential accident that could occur based on this predicted movement. The program code utilizes machine learning to train one or more algorithms which the program code can apply. The program code learns various aspects that it applies when predicting reflexive movements and determining whether these reflexive movements have a threshold probability of causing an accident or other hazardous condition. In some examples, the program code trains various algorithms to enable the program code to identify activities in a work environment or any other setting that would result in reflexive actions. The program code utilizes historical data related activities in a work environment or any other setting that would result in reflexive actions to build a knowledge corpus. The program code learns motions of different kinds from various objects and equipment in various physical environments. The program code learns, based on historical data, which potential accidents have happened or have a high probability of occurring due to the presence of objects in physical environments. The program code learns prevention actions that can be used to mitigate various types of anticipated accidents. For example, the program code can recommend that an individual wear certain protective gear to prevent injury based on a predicted reflexive action. In some examples, the program code can recommend implementing changes to a physical space (e.g., a workspace) to mitigate an anticipated accident (based on a predicted reflexive movement).

Various aspects of some embodiments of the present invention provide significantly more than present approaches to accident mitigation in physical spaces. For example, some existing approaches are reactive to issues and can include logging various actions in physical spaces as they occur and recommending actions based on those logged actions, providing safety notifications upon the occurrence of an accident, and providing personal protective equipment to mitigate general (but not specifically anticipated) issues. Meanwhile, examples herein provide a significant advantage over these approaches because they are proactive rather than reactive. Certain examples herein can utilize machine learning to anticipate reflexive actions before they occur and leverage AR glasses and wearable devices to notify individuals of anticipated accidents. The program code can mitigate accidents by predicting a reflexive action that could lead to an accident, notifying an individual of the prediction, in-real time or close to real-time, and recommending mitigating actions (e.g., to avoid an impact) to an individual, by providing those actions to an individual as a step-by-step guide via AR glasses and one or more wearable devices. Thus, unlike existing approaches, the program code in the examples herein can provide pro-active recommendations and situation-based guidance to mitigate an anticipated accident. In embodiments of the present invention, program code predicts movements and directions of the movements of an individual's reflexive actions (e.g., while performing an activity), in response to a stimulus. Because the program code can predict the movement and direction of the movement of the individual, the program code can determine whether the movement carries a risk of an accident and can recommend actions and/or implement actions to prevent an anticipated accident, including accidents that would involve surrounding equipment or objects in a workspace or other surrounding context.

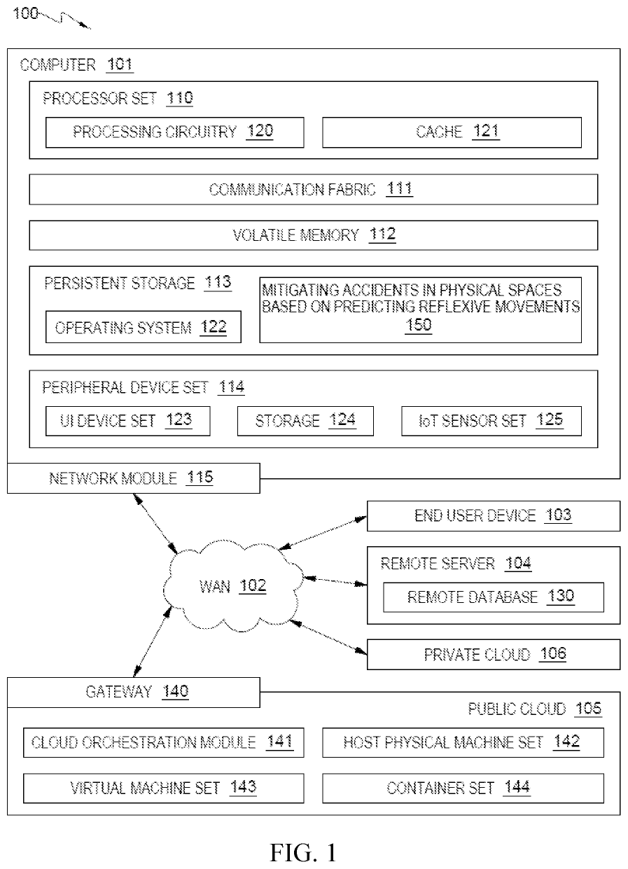

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for mitigating accidents in physical spaces based on predicting reflexive movements of inhabitants of the physical spaces 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

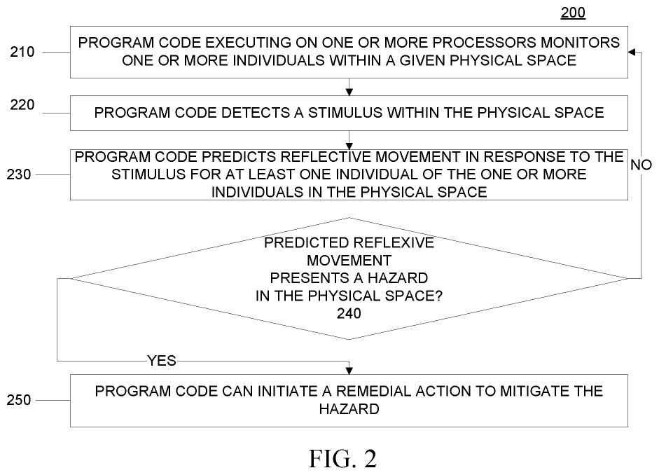

FIG. 2 is a workflow 200 that provides a general overview of various aspects of some embodiments of the present invention. In some embodiments of the present invention, program code executing on one or more processors monitors one or more individuals within a given physical space (210). As part of monitoring the environment, the program code can obtain input data corresponding to the activities performed (or engaged in) by the one or more individuals in the physical space. The program code can utilize various computing devices within the physical space to monitor the individuals, with the permission and awareness of the individual. These devices can include Internet of Things (IoT) devices, which can be wearable devices. For example, the program code can monitor physical movements of the individuals and store these movements within a corpus. The program code can build a corpus related to general movement and well as personalizing historical data related to a given individual in the physical space. The program code can obtain these data based on monitoring the user utilizing one or more IoT devices registered to the user and/or utilizing various devices integrated with a computing device. In some embodiments of the present invention, the user can provide permission to the program code to access the IoT device(s) and/or the devices of a computing device for the purpose of motion monitoring. The user can actively register the IoT device(s) to provide permission and actively enable the program code to use of the integrated devices for the purpose of monitoring the user (e.g., individual within the physical space). Thus, any monitoring of the user performed by the program code is performed with the permission of the user and for the purpose of accident mitigation within the physical space.

As understood by one of skill in the art, the Internet of Things (IoT) is a system of interrelated computing devices, mechanical and digital machines, objects, animals and/or people that are provided with unique identifiers and the ability to transfer data over a network, without requiring human-to-human or human-to-computer interaction. These communications are enabled by smart sensors, which include, but are not limited to, both active and passive radio-frequency identification (RFID) tags, which utilize electromagnetic fields to identify automatically and to track tags attached to objects and/or associated with objects and people. Smart sensors, such as RFID tags, can track environmental factors related to an object or an area, including but not limited to, temperature and humidity. The smart sensors can be utilized to measure temperature, humidity, vibrations, motion, light, pressure and/or altitude. IoT devices also include individual activity and fitness trackers, which include (wearable) devices or applications that include smart sensors for monitoring and tracking fitness-related metrics such as distance walked or run, calorie consumption, and in some cases heartbeat and quality of sleep and include smartwatches that are synced to computers or smartphones for long-term data tracking. Because the smart sensors in IoT devices carry unique identifiers, a computing system that communicates with a given sensor can identify the source of the information. Although in some embodiments of the present invention, users actively register IoT devices for utilization by the program code, in some embodiments of the present invention, the program code could automatically discover possible IoT devices and request confirmation from the user. Within the IoT, various devices can communicate with each other and can access data from sources available over various communication networks, including the Internet. Certain IoT devices can also be placed at various locations and can provide data based in monitoring environmental factors at the locations.

In embodiments of the present invention, the program code can utilize one or more IoT devices to monitor movements of one or more individuals with a given physical space (210). IoT devices can monitor and capture user activity through the collection of a wide range of data. IoT devices can collect video, image, movement, and audio data, all of which can assist the program code in chronicling the movements of a user, including reflexive movements. In monitoring and then, saving, in a corpus, reflexive movements of individuals, when confronted with various stimuli in the physical environment, the program code can utilize an IoT device to capture an image and/or video of the individual, from which the program code can determine the stimulus, the reflexive response of the user to the stimulus, and the direction of the reflexive response of the user to the stimulus.

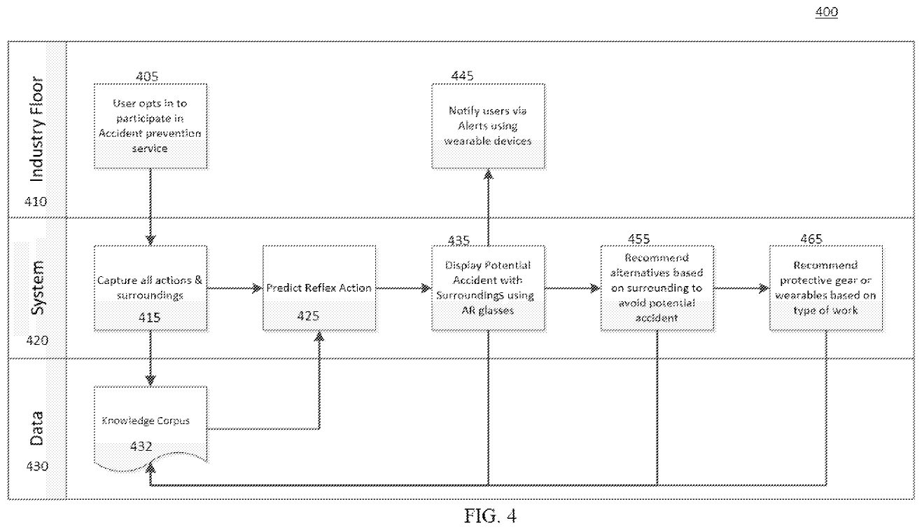

In some embodiments of the present invention, the program code monitors individuals in a physical space and by utilizing data collected by available (registered) IoT devices, and can apply machine learning algorithms to model the user's activity patterns and to generate a user profile for each individual and/or a general profile, that chronicles an individual's responses to a stimulus (or different types of stimuli) in a physical space, including movement in response to the stimulus and a direction for the movement. The program code can train these algorithms, based on patterns for the user (or across all users). The program code detects a stimulus within the physical space (220). The program code can utilize IoT devices and/or other devices and sensors in the physical space and worn by individuals within the space to detect stimuli. Based on detecting the stimulus, the program code can predict a reflective movement in response to the stimulus for at least one individual of the one or more individuals in the physical space (230). The program code can determine if the predicted reflexive movement presents a hazard in the physical space (240). In some embodiments, the program code will take further action (e.g., to initiate mitigation and/or to alert a user) only if the program code determined that the likelihood of a hazard (based on the reflexive movement) is above a pre-determined threshold, based on historical trends. In some embodiments, the program code can utilize the model it generates as a classifier to bucket anticipated reflexive movements and/or resultant hazards based on likelihood. The program code can progress to mitigating anticipated hazards based on a pre-determined likelihood. For example, the program code can predict that the reflexive movement has a pre-defined threshold probability of causing an injury should the individual engage in the predicted reflexive movement. As discussed earlier, the program code can utilize machine learning to predict the movement and to determine if the movement represents a hazard. If the program code determines that a predicted movement does not represent a hazard (240), for example, based on a location of an individual who is predicted to move not being proximate to any objects which, combined with the movement, would result in a hazard, the program code can continue monitoring (which it can do contemporaneously in some examples and thus would not cease monitoring while determining when there is a hazard). Should the program code predict a hazard (240), the program code can mitigate the hazard through various actions, some of which are described in more detail in FIG. 4.

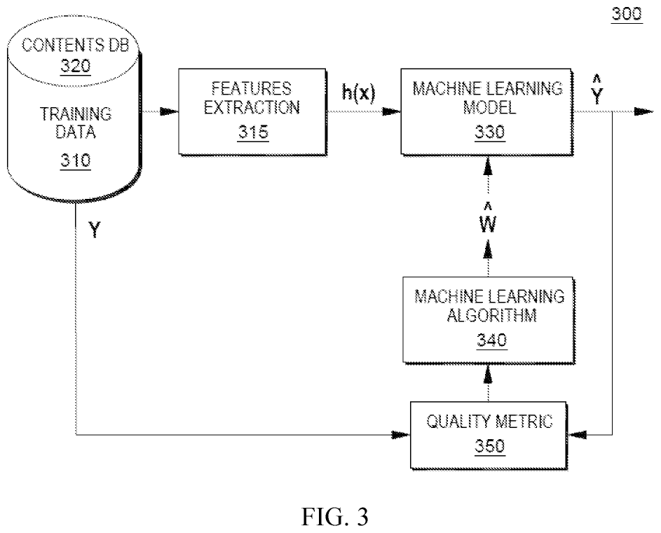

FIG. 3 is an example of a machine learning training system 300 that can be utilized to perform cognitive analyses of sensor and IoT data to generate a user reflexive movement profile (and/or a general reflexive movement (motion) profile for all individuals in a physical space over time) in embodiments of the present invention. The program code can utilize machine learning to predict reflexive movements of the one or more individuals in the physical space by analyzing input data corresponding to historical data from the one or more individuals to determine the historical reflexive actions for the one or more individuals. The program code can then output or automatically initiate remedial actions, which can be tailored to the one or more individuals based on the historical reflexive motions. Program code can obtain data in embodiments of the present invention from one or more personal devices (e.g., IoT devices, sensors, personal health trackers, physical activity trackers, smart watches, etc.), which a user can be utilizing while in a physical space. Program code in an embodiment of the present invention can obtain data from these personal devices indicating movements of the individual(s) and to what the individual is responding when moving. For example, a personal device worn by the user can include an accelerometer and/or a gyroscope. The program code can utilize these motion sensing devices to identify the types and directions of the reflexive motions and to what stimulus in the physical environments the individuals are responding to when engaged in these reflexive motions.

In some embodiments of the present invention, the program can generate a reflexive movement profile for a given user. The profile includes machine learned activity and/or movement patterns for the given user when confronted with various stimuli, based on the monitoring. The profile can include an anticipated movement in response to a given stimuli (including the direction of the responsive movement), a probability of this response, and a probability that this response will result in an environmental hazard in the physical space. For example, based on monitoring a user over time, program code determines that the user will jerk upwards responsive to sudden loud noises in the physical space. Thus, moving forward, the program code can predict that if the user is confronted with a sudden loud noise, the user will move in the anticipated direction and manner. The program code can also determine that when the user responds in this manner, there is a sixty percent chance that the movement will result in the individual becoming injured.

Machine learning (ML) solves problems that cannot be solved by numerical means alone. In this ML-based example, program code extracts various features/attributes from training data 310, which can be resident in one or more databases 320, which can comprise IoT data (e.g., sensor data). In some embodiments of the present invention, the training data 310 can comprise historical reflexive movement data of the user and/or of various individuals within a given physical space and records of impacts of these reflexive movements. The features are utilized to develop a predictor function, h(x), also referred to as a hypothesis, which the program code utilizes as a machine learning model 330. In identifying various features/attributes (e.g., patterns) in the training data 310, the program code can utilize various techniques including, but not limited to, mutual information, which is an example of a method that can be utilized to identify features in an embodiment of the present invention. Further embodiments of the present invention utilize varying techniques to select features (elements, patterns, attributes, etc.), including but not limited to, diffusion mapping, principal component analysis, recursive feature elimination (a brute force approach to selecting features), and/or a Random Forest, to select the features. The program code can utilize a machine learning algorithm 310 to train the machine learning model 330 (e.g., the algorithms utilized by the program code), including providing weights for the conclusions, so that the program code can predict reflexive movements of a user when confronted with a specific stimulus and determine whether a predicted reflexive movement will create (within a threshold probability) a hazard in physical space, in accordance with the predictor functions that comprise the machine learning model 330. The conclusions can be evaluated by a quality metric 350. By selecting a diverse set of training data 310, the program code trains the machine learning model 330 to identify and weight various attributes (e.g., features, patterns) that correlate to various movements and resultant (anticipated) hazards. Based on modeling the user's reflexive reactions and their impacts in the physical space, the program code can determine whether temporal sensor data represents an established pattern, indicating that the user has a (threshold) probability of moving in a manner that creates a hazard in the physical space.

In these examples, the training data 310 (which can be saved in a corpus by the program code) and utilized to train a model or one or more algorithms can include various types of data. The program code can learn from these data, which can include, but are not limited to activities in the physical space and/or other relevant environments that have resulted in reflexive motion/movement, motion of different kinds from various objects and equipment (which could potentially be disturbed by a reflexive movement of an individual), and prevention methods for various hazards and/or accidents in a physical space.

Returning to FIG. 2, based on the program code determining that the predicted reflexive movement presents the hazard in the physical space, the program code can initiate a remedial action to mitigate the hazard (250). For example, if the program code predicts that a given movement of an individual will result in an injury to that user, the program code can alert the user to the issue in order to prevent this injury in advance of its occurrence. Thus, the remedial can include a recommendation to prevent the reflexive movement. As discussed, relative to FIG. 300, the program code can generate and train a model (and various algorithms) that are customized to a given individual and/or that are general and hence applicable to all individuals within a physical space. Thus, the remedial action generated and provided (and in some examples, automatically initiated) by the program code can be customized (by the program code) to the individual who is anticipated to move in an unsafe manner, based on historical data from that user and/or can be a general recommendation that the program code derives from a general model that was trained by the program code utilizing data from various individuals in the physical space, over time.

FIG. 4 illustrates a system and an accompanying workflow 400 in which aspects of the examples herein have been implemented. In the system and workflow 400, program code executing on one or more processors utilizes historical learning to predict user's (e.g., individual's) movement and a potential accident that could occur because of this movement. Elements of the system and workflow 400 include a data layer 430 and a system layer 420. Also included is the physical space which benefits from the implementation of the system 400. The physical space in this example is an industry floor 410. This example is provided for illustrative purposes only and not to suggest any limitations. As illustrated in FIG. 4, individuals within the physical space, in this case, on the industry floor 410, opt into participation in an accident prevention service (405). As discussed in reference to FIGS. 2-3, the program code can perform this monitoring based on collecting data from IoT devices associated with the individuals and/or IoT or other devices within the physical space. The program code obtains the opt in and proceeds to capture both the actions of the individuals and environmental data (415). The program code trains a model to predict reflexive actions of individuals and whether these reflexive actions represent environmental hazards (e.g., could result in accidents on the industry floor 410) and the training data is contained in a knowledge corpus 432. The knowledge corpus 432 includes data collected by the program code when monitoring the individuals and their surroundings (415) over time. The program code learns (e.g., trains a model to determine): activities performed by individuals in the physical environment and any other setting that would result in reflex actions to build a knowledge corpus. The knowledge corpus 432 can include but is not limited to: activities in the physical space and/or other relevant environments (e.g., on the industry floor 410) that have resulted in reflexive motion/movement, motion of different kinds from various objects and equipment (which could potentially be disturbed by a reflexive movement of an individual), and prevention methods for various hazards and/or accidents in the physical space. The program code builds the knowledge corpus 432 and this knowledge corpus 432 facilitates preferred states of various types of activities pertaining to situational reflexes of humans. The program code, based on machine learning, can predict the movement and direction of an individual's reflexive action or movement, while the individuals is engaged in a given activity, because of a stimulus experienced by the individual in the physical space, based on applying a model that the program code trained using the knowledge corpus 432 (425).

The historical data (which the program code obtains both from monitoring individuals but can also obtain from other sources accessible to the program code, including public safety databases), enables the program code to predict reflexive movements of individuals and not only determine whether hazards can occur but also to weight the seriousness of potential hazards. Various factors in the data can indicate a more serious risk. For example, the type of motion that is anticipated as a reflexive movement can be indicative of the seriousness. Also, the anticipated location of the user when the user experiences the reflexive motion can be determinative of the seriousness of the hazard. As illustrated in FIG. 3, the program code can identify various patterns in the data and utilize these patterns to weigh risks when various movements are predicted. Various factors which could impact anticipated risk can include, but are not limited to, motion of different kinds from various objects and equipment (which are interacted with because of the reflexive motion) and speed, including quantifiable speed of objects that may be working with or being used by the individual who is predicted to experience a reflexive motion (e.g., inferring motion). The program code can predict potential accidents that may have happened or can occur due to the objects in the physical space 410. The program code can define high risk areas of the physical space where a reflexive is more dangerous. Thus, the program code can monitor the individuals including their locations within the space and their proximity to various objects in the space.

Program code in examples herein alerts a user to an anticipated hazard and guides the user through remedial actions to prevent the hazard. When the program code predicts that a user will move reflexively based on a stimulus (425), the program code alerts the user to the predicted movement and the subsequent potential risk (of a hazard) that the movement presents. The program generates a visualization of the reflexive action and the anticipated hazard utilizing AR. Specifically, the program code generates and displays a visualization of a potential accident predicted by the program code (utilizing the trained model) and superimposes this (predicted) virtual scenario on the real-world industry floor 410 surroundings. The program code displays this visualization in AR glasses worn by an individual to whom the program code is conveying this information. The visualization of the surroundings together with the potential hazard, utilizing AR technology, is particularly helpful to the individual because this full view of the physical environment in the context of the potential hazard can help prevent the hazard or accident from occurring because the user can see how the reflexive movement contributes to the hazard, but also, how surrounding equipment or objects in the physical space (e.g., workshop, industry floor 410, etc.) and other surrounding context would potentially contribute to the hazard. The program code can also project the visualization of the potential accident in the physical surroundings (e.g., on wall or a floor of the industry floor 410). The program code can alert the individual or individuals to the predicted hazard via wearable devices, including the wearable devices that the program code utilizes to monitor the individuals (445).

In addition to alerting (445) an individual to a potential hazard (based on a predicted response to a stimulus), the program code can implement proactive measures to prevent and/or mitigate anticipated hazards or accidents. Thus, the program code not only detects a problematic situation and alerts individuals to the risks, but the program code can also guide the individuals in avoiding the risks. For example, if the program code determines that the user will experience a reflexive action in close proximity to an area of the industry floor 410 proximate to an object that, if jostled, would present a hazard (and the program code has determined that, based on historical data, there is a (pre-determined) threshold likelihood that the object will be jostled based on the individual's location), the program code can recommend to the individual to move away from the object.

The program code can generate a visualization and display the visualization with the AR glasses that includes alternative steps that an individual can follow to proactively prevent the hazard predicted by the program code from occurring (455). For example, the program code can recommend that the individual avoid an area on the industry floor 410. The program code can create a visualization of steps that the individual can take to mitigate a risk, including, but not limited to, moving certain objects from one location on the industry floor 410 to another. One way to dampen the effects of environmental stimuli on an individual in that environment is to recommend to the user to wear protective gear. In some examples, the program code can recommend that the user wear protective gear to dampen and/or prevent reflexive reactions to stimuli (465). This gear can include, but is not limited to, head protection (e.g., to limit responses to getting hit in the head with lying objects), eye protection (e.g., to limit responses dust or particle, metal shavings, acids, caustic liquids, welding light, etc.), hearing protection (e.g., to limit responses to loud tools and machinery and poorly maintained equipment), high visibility clothing including hats, vests, and pants (e.g., to limit responses errant vehicles, distracted drivers), chaps (e.g., to limit responses chainsaws), hand protection (e.g., to limit responses sharp or hot objects, chemicals, biological or electrical hazards), foot protection (e.g., to limit responses falling or rolling objects, sharp or heavy objects, wet and slippery surfaces, uneven surfaces, hot surfaces, electrical hazards, etc.) and harness lanyards (e.g., to limit responses to stimuli occurring while working more than ˜6 or more feet above a lower level).

Embodiments of the present invention include computer-implemented methods, computer program products, and computer systems that comprise program code executing on one or more processors that anticipate and mitigate hazardous conditions in a physical space comprising. In some examples, the program code monitors one or more individuals within the physical space. The program code detects a stimulus within the physical space. The program code determines, based on applying a trained machine learning model, that the stimulus will result in a hazardous condition in the physical space. To make this determination, the program code predicts, based on the model, that the stimulus will trigger a reflexive movement of at least one individual of the one or more individuals in the physical space and the program code determines, based on the model and based on the predicted reflexive movement that the reflexive movement will result in a hazardous condition in the physical space. The program code initiates a remedial action to mitigate the hazardous condition.

In some examples, the program code initiates the remedial action by generating a visualization of the predicted reflexive movement and the hazardous condition and projecting, as a virtual overlay to at least a portion of the physical space, the visualization.

In some examples, the program code projecting comprises the program code utilizing an augmented reality output device to project a real-time image of the portion of the physical space and the virtual overlay.

In some examples, the augmented reality output device comprises augmented reality glasses worn by the at least one individual.

In some examples, the remedial action comprises the program code alerting the at least one individual of the hazardous condition via a wearable device worn by the at least one individual.

In some examples, the program code monitoring the one or more individuals within the physical space comprises: the program code identifying one or more computing resources proximate to the one or more individuals, and the program code utilizing the one or more computing resources to track movements of the user to determine if the movements comprise reflexive movements based on stimuli in the environment.

In some examples, at least one computing resource of the one or more computing resources comprises an Internet of Things device.

In some examples, the program code identifying the one or more resources comprises the program code obtaining a registration, from an individual of the one or more individuals, via the given computing device, of the one or more computing resources.

In some examples, the program code monitoring the one or more individuals within the physical space comprises: the program code identifying one or more computing resources proximate to the one or more individuals, the program code utilizing the one or more computing resources to monitor physical activities of the one or more individuals, comprising movements of the one or more individuals, and the program code generating a reflexive movement profile for at least one of the one or more individuals, wherein the reflexive movement profile comprises machine learned movement patterns for the one individual, based on the monitoring. The movement profile comprises a measure indicating a probability of a movement pattern of the movement patterns creating a hazardous condition in the physical space. The reflexive movement profile comprises a portion of the model.

In some examples, the program code identifies, based on the monitoring, the at least one of the one or more individuals performing a given movement pattern with the measure indicating the probability the given movement pattern creating the hazardous condition of above a predefined threshold value that the given movement pattern indicates the hazardous condition.

In some examples, the program code trains the machine learning model with data comprising a corpus and the data comprises data obtained based on the monitoring.

In some examples, the data also include information selected from the group consisting of historical activities in the physical space, historical hazardous conditions in the physical space, historical activities in spaces similar to the physical space, motion of objects in the physical space, and prevention methods to address various historical hazardous conditions in the physical space.

In some examples, the program code determining that the reflexive movement will result in the hazardous condition in the physical space is also based on at least one element of the physical space proximate to the least one individual.

In some examples, the remedial action is selected from the group consisting of: automatically moving at least one object in the physical space and recommending a physical change to the physical space.

In some examples, projecting comprises utilizing the augmented reality output device to project a real-time image of the portion of the physical space and the virtual overlay, and the projecting comprises generating and projecting a visual simulation of the remedial action.

Various additional examples of the computer-implemented methods, computer program products, and computer systems are described below, and these examples, including and excluding the additional examples enumerated below, in any combination (provided these combinations are not inconsistent), can also mitigate safety issue in a physical space.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for anticipating and mitigating hazardous conditions in a physical space comprising:
monitoring, by one or more processors, one or more individuals within the physical space;
detecting, by the one or more processors, a stimulus within the physical space;
determining, by the one or more processors, based on applying a trained machine learning model, that the stimulus will result in a hazardous condition in the physical space, the determining comprising:
predicting, by the one or more processors, based on the model, that the stimulus will trigger a reflexive movement of at least one individual of the one or more individuals in the physical space; and
determining, by the one or more processors, based on the model and based on the predicted reflexive movement that the reflexive movement will result in a hazardous condition in the physical space; and
initiating, by the one or more processors, a remedial action to mitigate the hazardous condition.

2. The computer-implemented method of claim 1, wherein initiating the remedial action comprises:
generating, by the one or more processors, a visualization of the predicted reflexive movement and the hazardous condition; and
projecting, by the one or more processors, as a virtual overlay to at least a portion of the physical space, the visualization.

3. The computer-implemented method of claim 2, wherein the projecting comprises utilizing an augmented reality output device to project a real-time image of the portion of the physical space and the virtual overlay.

4. The computer-implemented method of claim 3, wherein the augmented reality output device comprises augmented reality glasses worn by the at least one individual.

5. The computer-implemented method of claim 1, wherein the remedial action comprises alerting the at least one individual of the hazardous condition via a wearable device worn by the at least one individual.

6. The computer-implemented method of claim 1, wherein monitoring the one or more individuals within the physical space comprises:
identifying, by the one or more processors, one or more computing resources proximate to the one or more individuals; and
utilizing, by the one or more processors, the one or more computing resources to track movements of the user to determine if the movements comprise reflexive movements based on stimuli in the environment.

7. The computer-implemented method of claim 6, wherein at least one computing resource of the one or more computing resources comprises an Internet of Things device.

8. The computer-implemented method of claim 7, wherein identifying the one or more resources comprises obtaining, by the one or more processors, a registration, an individual of the one or more individuals, via the given computing device, of the one or more computing resources.

9. The computer-implemented method of claim 1, wherein monitoring the one or more individuals within the physical space comprises:
identifying, by the one or more processors, one or more computing resources proximate to the one or more individuals;
utilizing, by the one or more processors, the one or more computing resources to monitor physical activities of the one or more individuals, comprising movements of the one or more individuals; and
generating, by the one or more processors, a reflexive movement profile for at least one of the one or more individuals, wherein the reflexive movement profile comprises machine learned movement patterns for the one individual, based on the monitoring, wherein the movement profile comprises a measure indicating a probability of a movement pattern of the movement patterns creating a hazardous condition in the physical space, wherein the reflexive movement profile comprises a portion of the model.

10. The computer-implemented method of claim 9, further comprising:
identifying, based on the monitoring, the at least one of the one or more individuals performing a given movement pattern with the measure indicating the probability the given movement pattern creating the hazardous condition of above a predefined threshold value that the given movement pattern indicates the hazardous condition.

11. The computer-implemented method of claim 1, further comprising:
training, by the one or more processors, the machine learning model with data comprising a corpus, wherein the data comprises: data obtained based on the monitoring.

12. The computer-implemented method of claim 11, wherein the data further comprises information selected from the group consisting of: historical activities in the physical space, historical hazardous conditions in the physical space, historical activities in spaces similar to the physical space, motion of objects in the physical space, and prevention methods to address various historical hazardous conditions in the physical space.

13. The computer-implemented method of claim 1, wherein the determining that the reflexive movement will result in the hazardous condition in the physical space is also based on at least one element of the physical space proximate to the least one individual.

14. The computer-implemented method of claim 1, wherein the remedial action is selected from the group consisting of: automatically moving at least one object in the physical space and recommending a physical change to the physical space.

15. The computer-implemented method of claim 2, wherein the projecting comprises utilizing the augmented reality output device to project a real-time image of the portion of the physical space and the virtual overlay, wherein the projecting comprises generating and projecting a visual simulation of the remedial action.

16. A computer system comprising:
a memory; and
one or more processors in communication with the memory, wherein the computer system is configured to perform a method, said method comprising:
monitoring, by the one or more processors, one or more individuals within the physical space;
detecting, by the one or more processors, a stimulus within the physical space;
determining, by the one or more processors, based on applying a trained machine learning model, that the stimulus will result in a hazardous condition in the physical space, the determining comprising:
predicting, by the one or more processors, based on the model, that the stimulus will trigger a reflexive movement of at least one individual of the one or more individuals in the physical space; and
determining, by the one or more processors, based on the model and based on the predicted reflexive movement that the reflexive movement will result in a hazardous condition in the physical space; and
initiating, by the one or more processors, a remedial action to mitigate the hazardous condition.

17. The computer system of claim 16, wherein initiating the remedial action comprises:
generating, by the one or more processors, a visualization of the predicted reflexive movement and the hazardous condition; and
projecting, by the one or more processors, as a virtual overlay to at least a portion of the physical space, the visualization.

18. The computer system of claim 17, wherein the projecting comprises utilizing an augmented reality output device to project a real-time image of the portion of the physical space and the virtual overlay.

19. A computer program product for anticipating and mitigating hazardous conditions in a physical space comprising:
a computer readable storage media having program instruction embodied therewith, the program instructions executable by a processing circuit, to cause the processing circuit to:
monitor, by the one or more processors, one or more individuals within the physical space;
detect, by the one or more processors, a stimulus within the physical space;
determine, by the one or more processors, based on applying a trained machine learning model, that the stimulus will result in a hazardous condition in the physical space, the determining comprising:
predict, by the one or more processors, based on the model, that the stimulus will trigger a reflexive movement of at least one individual of the one or more individuals in the physical space; and
determine, by the one or more processors, based on the model and based on the predicted reflexive movement that the reflexive movement will result in a hazardous condition in the physical space; and
initiate, by the one or more processors, a remedial action to mitigate the hazardous condition.

20. The computer program product of claim 19, wherein initiating the remedial action comprises:
generating, by the one or more processors, a visualization of the predicted reflexive movement and the hazardous condition; and
projecting, by the one or more processors, as a virtual overlay to at least a portion of the physical space, the visualization.
